(19) United States
(12) Patent Application Publication
(10) Pub. No.: US 2005/0204138 A1
(43) Pub. Date: Sep. 15, 2005

(54) System and method for an email screen saver

(75) Inventor: Chen-Yuan Chiu, Hsinchu County (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/799,497

(22) Filed: Mar. 12, 2004

(51) Int. Cl. H04L 9/00

(52) U.S. Cl. 713/170

(57) ABSTRACT

The present disclosure provides a system and method for an email screen saver. In one example, the method includes monitoring for activity and, if no activity is detected within a predefined period of time, activating a screen saver. If a message is received, the method determines whether the screen saver is active and identifies a message notification configuration if the screen saver is active, where the message notification configuration identifies at least one user-defined destination at which a user is to be notified. The user is notified of the received message at the destination. An authorization routine is then executed to determine whether the user has entered a correct authorization code, and the message is provided to the user at the destination without disabling the screen saver if the user has entered the correct authorization code.

### BACKGROUND

The present disclosure relates generally to the field of digital communications in semiconductor fabrication facilities and, more particularly, to a system and method for an email screen saver to provide secure messaging.

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing have been needed. For example, an IC is formed by creating one or more devices (e.g., circuit components) on a substrate using a fabrication process. As the geometry of such devices is reduced to the submicron or deep submicron level, the IC's active device density (i.e., the number of devices per IC area) and functional density (i.e., the number of interconnected devices per IC area) has become limited by the fabrication process.

Furthermore, as the IC industry has matured, the various operations needed to produce an IC may be performed at different locations by a single company or by different companies that specialize in a particular area. This further increases the complexity of producing ICs, as companies and their customers may be separated not only geographically, but also by time zones, making effective communication more difficult. For example, a first company (e.g., an IC design house) may design a new IC, a second company (e.g., an IC foundry) may provide the processing facilities used to fabricate the design, and a third company may assemble and test the fabricated IC. A fourth company may handle the overall manufacturing of the IC, including coordination of the design, processing, assembly, and testing operations.

Accordingly, what is needed is a system and method for improved communication.

### BRIEF DESCRIPTION OF THE DRAWINGS

FIG. 1 is a flowchart of one embodiment of a method for secure messaging using an email screen saver.

FIG. 2 is a diagram of an exemplary virtual fabrication system within which the method in FIG. 1 may be performed.

FIG. 3 is a more detailed diagram of the exemplary virtual fabrication system of FIG. 2.

FIG. 4 is a diagram of an email system that may be used within the virtual fabrication system of FIG. 2.

FIG. 5 is a flowchart of another embodiment of a method for secure messaging using an email screen saver.

FIG. 6 is an exemplary window that may be used to notify a user of a received message while a screen saver is active.

FIG. 7 is an exemplary window that may be used by a user to respond to a message while a screen saver is active.

### DETAILED DESCRIPTION

The present disclosure relates generally to the field of digital communications in semiconductor fabrication facilities and, more particularly, to a system and method of using an email screen saver to provide secure messaging. It is understood, however, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

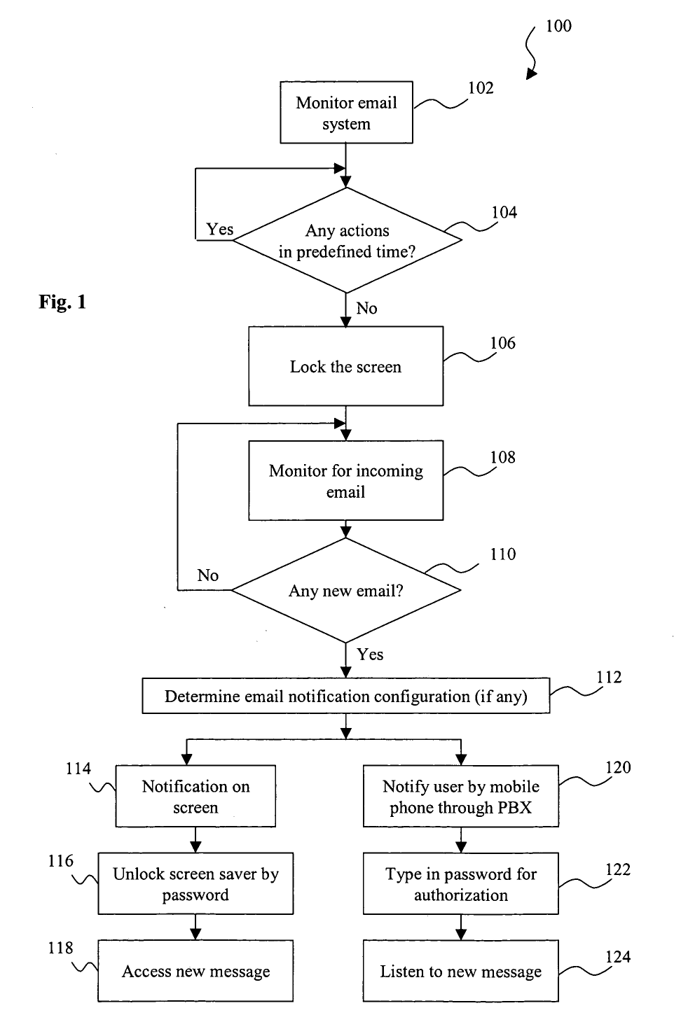

Referring to FIG. 1, in one embodiment, a method 100 enables the configuration of security settings, forwarding options, and other email handling processes for a digital device such as a computer. The method 100 begins in step 102 by monitoring user activity. If user activity is occurring as determined in step 104 (e.g., input is received via a keyboard, a mouse, etc., associated with the computer), steps 102, 104 may be repeated. If no user activity occurs for a predefined period of time, the method 100 continues to step 106 and locks a screen associated with the computer by activating a screen saver. Although not shown in the method 100, it is understood that the screen may be unlocked at any time by a user entering a predetermined username and/or password.

In steps 108 and 110, an email monitoring process determines whether an email message has been received. If no message is received, steps 108 and 110 repeat. If a message has been received, the method 100 continues to step 112, where an email notification configuration may be determined. In the present example, the email notification configuration enables a user to select notification via the computer or via a mobile telephone. In some embodiments, the user may select multiple notification types (e.g., via the computer, via email to another device such as a pager, and/or via the mobile phone).

If the user has selected notification via the computer, then the method 100 continues to step 114 and notifies the user. In step 116, the user may enter a username and/or password and, in step 118, the email is accessed by the user. If the user has selected notification via mobile phone, then the method 100 proceeds from step 112 to step 120 and connects to the user's mobile phone via a private branch exchange (PBX) or any other intermediary telecommunications system that may be needed. In step 122, the user enters a password and, in step 124, the user may listen to or read the email via mobile phone. It is understood that the authorization process is not limited to a username and/or password, but may include biometric identifiers such as sound comparisons, finger print comparisons, image comparisons, or handwriting sampling. Furthermore, in some embodiments, successful authorization may limit the user to retrieving the message without unlocking the screen itself. In still other embodiments, the user may be able to respond to the email without unlocking the screen. This enables a user to access the computer for received emails without being able to access any other information in the computer.

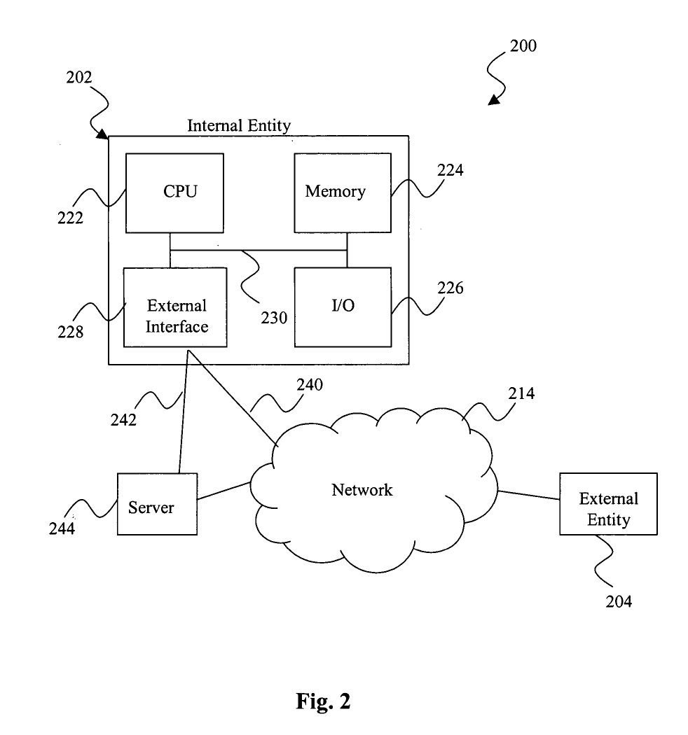

Referring now to FIG. 2, a virtual IC fabrication system (a “virtual fab”) 200 is one embodiment of a system that can be used to implement the method 100 of FIG. 1. The virtual fab includes a plurality of entities, represented by one or more internal entities 202 and one or more external entities 204 that are connected by a communications network 206. The network 206 may be a single network or may be a variety of different networks, such as an intranet and the Internet, and may include both wireline and wireless communication channels.

Each of the entities 202, 204 may include one or more computing devices such as personal computers, personal digital assistants, pagers, cellular telephones, and the like. For the sake of example, the internal entity 202 is expanded to show a central processing unit (CPU) 222, a memory unit 224, an input/output (I/O) device 226, and an external interface 228. The external interface may be, for example, a modem, a wireless transceiver, and/or one or more network interface cards (NICs). The components 222-228 are interconnected by a bus system 230. It is understood that the internal entity 202 may be differently configured and that each of the listed components may actually represent several different components. For example, the CPU 222 may actually represent a multi-processor or a distributed processing system; the memory unit 224 may include different levels of cache memory, main memory, hard disks, and remote storage locations; and the I/O device 226 may include monitors, keyboards, and the like.

The internal entity 202 may be connected to the communications network 214 through a wireless or wired link 240, and/or through an intermediate network 242, which may be further connected to the communications network. The intermediate network 242 may be, for example, a complete network or a subnet of a local area network, a company wide intranet, and/or the Internet. The internal entity 202 may be identified on one or both of the networks 214, 242 by an address or a combination of addresses, such as a media control access (MAC) address associated with the network interface 228 and an internet protocol (IP) address. Because the internal entity 202 may be connected to the intermediate network 242, certain components may, at times, be shared with other internal entities. Therefore, a wide range of flexibility is anticipated in the configuration of the internal entity 202. Furthermore, it is understood that, in some implementations, a server 244 may be provided to support multiple internal entities 202. In other implementations, a combination of one or more servers and computers may together represent a single entity.

In the present example, the internal entities 202 represents those entities that are directly responsible for producing the end product, such as a wafer or individually tested IC devices. Examples of internal entities 202 include an engineer, customer service personnel, an automated system process, a design or fabrication facility and fab-related facilities such as raw-materials, shipping, assembly or test. Examples of external entities 204 include a customer, a design provider; and other facilities that are not directly associated or under the control of the fab. In addition, additional fabs and/or virtual fabs can be included with the internal or external entities. Each entity may interact with other entities and may provide services to and/or receive services from the other entities.

It is understood that the entities 202-204 may be concentrated at a single location or may be distributed, and that some entities may be incorporated into other entities. In addition, each entity 202, 204 may be associated with system identification information that allows access to information within the system to be controlled based upon authority levels associated with each entities identification information.

The virtual fab 200 enables interaction among the entities 202-204 for purposes related to IC manufacturing, as well as the provision of services. In the present example, IC manufacturing can include one or more of the following steps:
receiving or modifying a customer's IC order of price, delivery, and/or quantity;
receiving or modifying an IC design;
receiving or modifying a process flow;
receiving or modifying a circuit design;
receiving or modifying a mask change;
receiving or modifying testing parameters;
receiving or modifying assembly parameters; and
receiving or modifying shipping of the ICs.

One or more of the services provided by the virtual fab 200 may enable collaboration and information access in such areas as design, engineering, and logistics. For example, in the design area, the customer 204 may be given access to information and tools related to the design of their product via the fab 202. The tools may enable the customer 204 to perform yield enhancement analyses, view layout information, and obtain similar information. In the engineering area, the engineer 202 may collaborate with other engineers 202 using fabrication information regarding pilot yield runs, risk analysis, quality, and reliability. The logistics area may provide the customer 204 with fabrication status, testing results, order handling, and shipping dates. It is understood that these areas are exemplary, and that more or less information may be made available via the virtual fab 200 as desired.

Another service provided by the virtual fab 200 may integrate systems between facilities, such as between a facility 204 and the fab facility 202. Such integration enables facilities to coordinate their activities. For example, integrating the design facility 204 and the fab facility 202 may enable design information to be incorporated more efficiently into the fabrication process, and may enable data from the fabrication process to be returned to the design facility 204 for evaluation and incorporation into later versions of an IC.

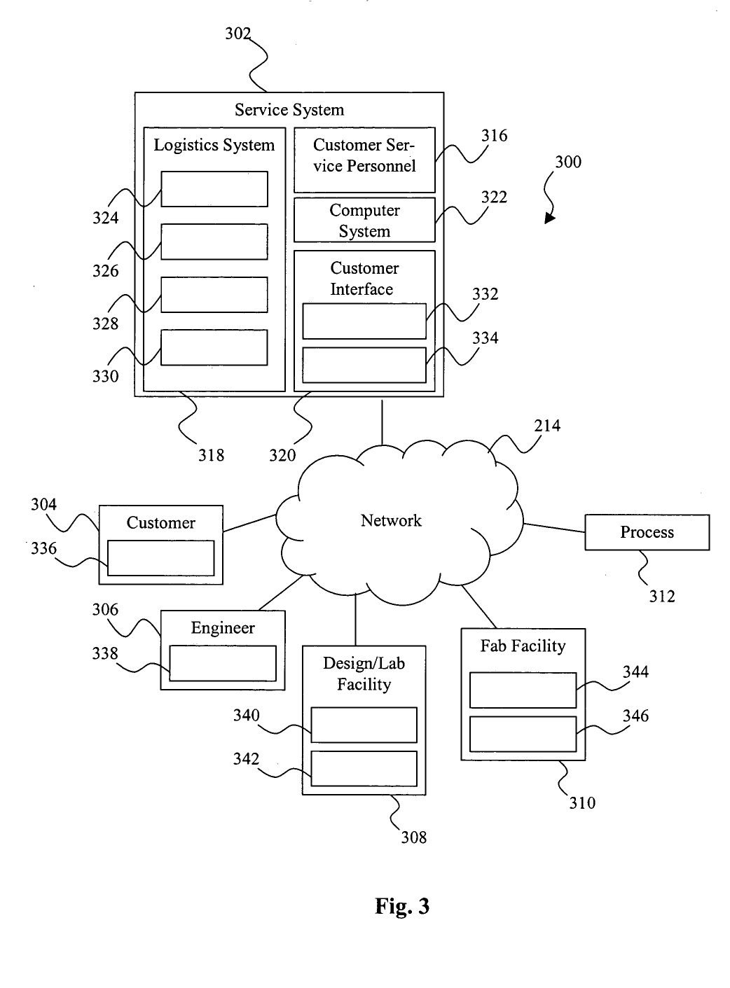

Referring now to FIG. 3, a virtual fab 300 illustrates a more detailed example of the virtual fab 200 of FIG. 2. It is understood, however, that the details mentioned and described in FIG. 3 are provided for the sake of example, and that other examples can also be used.

The virtual fab 300 includes a plurality of entities 302, 304, 306, 308, 310, and 312 that are connected by a communications network 314. In the present example, the entity 302 represents a service system, the entity 304 represents a customer, the entity 306 represents an engineer, the entity 308 represents a design/lab facility for IC design and testing, the entity 310 represents a fab facility, and the entity 312 represents a process (e.g., an automated fabrication process) either inside the fab 310, or at another facility. Each entity may interact with other entities and may provide services to and/or receive services from the other entities.

The service system 302 provides an interface between the customer and the IC manufacturing operations. For example, the service system 302 may include customer service personnel 316, a logistics system 318 for order handling and tracking, and a customer interface 320 for enabling a customer to directly access various aspects of an order.

The logistics system 318 may include a work-in-process (WIP) inventory system 324, a product data management system 326, a lot control system 328, and a manufacturing execution system (MES) 330. The WIP inventory system 324 may track working lots using a database (not shown). The product data management system 326 may manage product data and maintain a product database (not shown). The product database could include product categories (e.g., part, part numbers, and associated information), as well as a set of process stages that are associated with each category of products. The lot control system 328 may convert a process stage to its corresponding process steps.

The MES 330 may be an integrated computer system representing the methods and tools used to accomplish production. In the present example, the primary functions of the MES 330 may include collecting data in real time, organizing and storing the data in a centralized database, work order management, workstation management, process management, inventory tracking, and document control. The MES 330 may be connected to other systems both within the service system 302 and outside of the service system 302. Examples of the MES 330 include Promis (Brooks Automation Inc. of Massachusetts), Workstream (Applied Materials, Inc. of California), Poseidon (IBM Corporation of New York), and Mirl-MES (Mechanical Industry Research Laboratories of Taiwan). Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. The MES 330 may include such information as a process step sequence for each product.

The customer interface 320 may include an online system 332 and an order management system 334. The online system 332 may function as an interface to communicate with the customer 304, other systems within the service system 302, supporting databases (not shown), and other entities 306-312. The order management system 334 may manage client orders and may be associated with a supporting database (not shown) to maintain client information and associated order information.

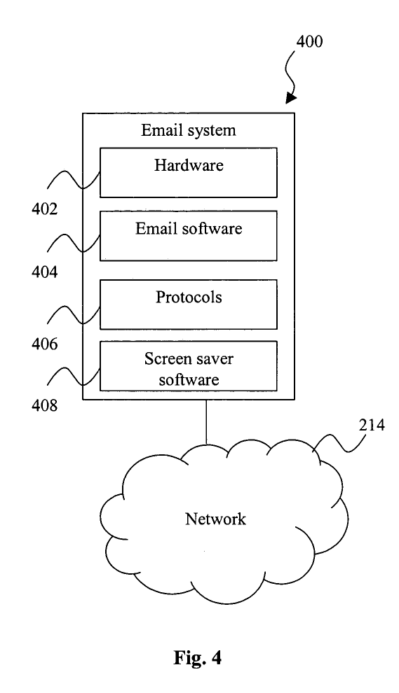

Portions of the service system 302, such as the customer interface 320, may be associated with a computer system 322 or may have their own computer systems. In some embodiments, the computer system 322 may include multiple computers (FIG. 4), some of which may operate as servers to provide services to the customer 304 or other entities. The service system 302 may also provide such services as identification validation and access control, both to prevent unauthorized users from accessing data and to ensure that an authorized customer can access only their own data.

The customer 304 may obtain information about the manufacturing of its ICs via the virtual fab 300 using a computer system 336. In the present example, the customer 304 may access the various entities 302, 306-312 of the virtual fab 300 through the customer interface 320 provided by the service system 302. However, in some situations, it may be desirable to enable the customer 304 to access other entities without going through the customer interface 320. For example, the customer 304 may directly access the fab facility 310 to obtain fabrication related data.

The engineer 306 may collaborate in the IC manufacturing process with other entities of the virtual fab 300 using a computer system 338. The virtual fab 300 enables the engineer 306 to collaborate with other engineers and the design/lab facility 308 in IC design and testing, to monitor fabrication processes at the fab facility 310, and to obtain information regarding test runs, yields, etc. In some embodiments, the engineer 306 may communicate directly with the customer 304 via the virtual fab 300 to address design issues and other concerns.

The design/lab facility 308 provides IC design and testing services that may be accessed by other entities via the virtual fab 300. The design/lab facility 308 may include a computer system 340 and various IC design and testing tools 342. The IC design and testing tools 342 may include both software and hardware.

The fab facility 310 enables the fabrication of ICs. Control of various aspects of the fabrication process, as well as data collected during the fabrication process, may be accessed via the virtual fab 300. The fab facility 310 may include a computer system 344 and various fabrication hardware and software tools and equipment 346. For example, the fab facility 310 may include an ion implantation tool, a chemical vapor deposition tool, a thermal oxidation tool, a sputtering tool, and various optical imaging systems, as well as the software needed to control these components.

The process 312 may represent any process or operation that occurs within the virtual fab 300. For example, the process 312 may be an order process that receives an IC order from the customer 304 via the service system 302, a fabrication process that runs within the fab facility 310, a design process executed by the engineer 306 using the design/lab facility 308, or a communications protocol that facilities communications between the various entities 302-312.

It is understood that the entities 302-312 of the virtual fab 300, as well as their described interconnections, are for purposes of illustration only. For example, it is envisioned that more or fewer entities, both internal and external, may exist within the virtual fab 300, and that some entities may be incorporated into other entities or distributed. For example, the service system 302 may be distributed among the various entities 306-310.

Referring now to FIG. 4, an exemplary email system 400, such as may be used within the virtual fab 200 of FIG. 2, is illustrated. The email system 500 includes hardware 502, software 504, a plurality of protocols 506, and email screen saver software 508. The hardware 502 may be a computer, a personal digital assistant (PDA), a wired or cellular phone, a pager, or any other device able to receive a message. The software 504 may be any email program. The plurality of protocols 506 may include Hyper Text Transfer Protocol (HTTP), Post Office Protocol, version 3 (POP3), Internet Message Access Protocol (IMAP), Simple Mail Transfer Protocol (SMTP), or any other suitable protocol. In the present example, the email screen saver 508 is illustrated as part of the email system 500. However, it is understood that it may be a separate module or component residing elsewhere on a network or storage device.

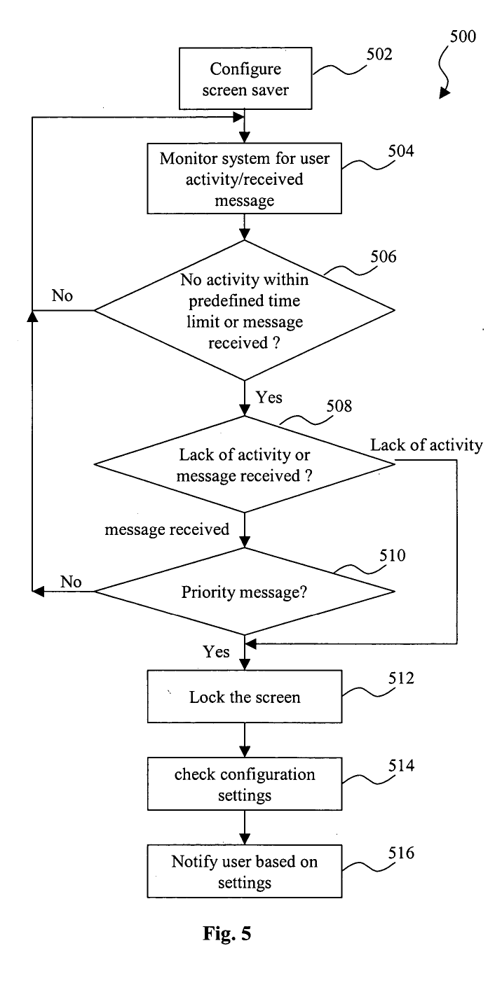

Referring now to FIG. 5, in another embodiment, a method 500 that may be used with email system 400 of FIG. 4 is illustrated. It is understood that the email system and email messages used in the present example are for purposes of illustration, and that other systems and message types may be secured in a similar manner. For example, instant messages, voicemails, and other messages may be securely handled as described.

In step 502, the method 500 enables a user or administrator to use the email system 400 to configure security settings, forwarding options, and other email handling processes for a digital device such as a computer. The configuration details may include a length of time that should elapse without user activity before starting the screen saver, setting a user name and/or password for regaining access to the computer after the screen saver is started, forwarding criteria that may be used to determine which emails should be forwarded and a destination for such emails, and similar information. The configuration enables the user to lock the screen when a triggering event occurs. In the present example, the triggering event may be the elapse of a predefined period of time without user activity or may be the receipt of an email having a predefined priority status.

In steps 504 and 506, the method 500 monitors user activity and/or receipt of email (e.g., monitors for the occurrence of a triggering event). If user activity is occurring and/or no email is received, then steps 504 and 506 may be repeated. If a predefined amount of time elapses without user activity or an email is received, the method 500 continues to step 508, where a determination is made as to whether the triggering event was a lack of activity or receipt of an email. If the triggering event was lack of activity, the method 500 continues to step 512 and locks the screen. If the triggering event was receipt of an email, the method 500 continues to step 510, where a determination is made as to whether the email is a priority email. If the email is not a priority email, the method 500 returns to step 504. If the email is a priority email, the screen is locked in step 512.

In step 514, the configuration settings are checked to determine how to notify the user (if the triggering event was an email). In step 516, the user is notified based on the configuration settings (e.g., via the computer, via email to another device such as a pager, via a mobile phone, etc.). The notification may include an authorization request for a username and/or password. Such an authorization request may include sound comparison, finger print comparison, an image password, or handwriting sampling. Furthermore, in some embodiments, successful authorization may limit the user to retrieve the message without unlocking the screen saver itself. In still other embodiments, the user may be able to respond to the email without unlocking the screen. This enables a user to access the computer for received emails without being able to access any other information in the computer. It is understood that other configuration settings may be implemented. For example, the screen may be locked or unlocked based on predefined triggering events.

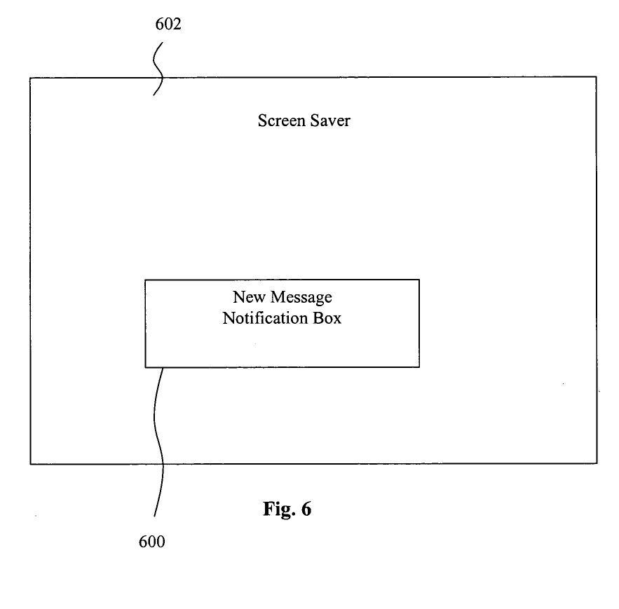

Referring now to FIG. 6, in another embodiment, an exemplary window 600 may be used to notify a user that email has been received while a screen saver 602 is running. For example, the window 600 may be a popup window that does not interfere with the screen saver 602.

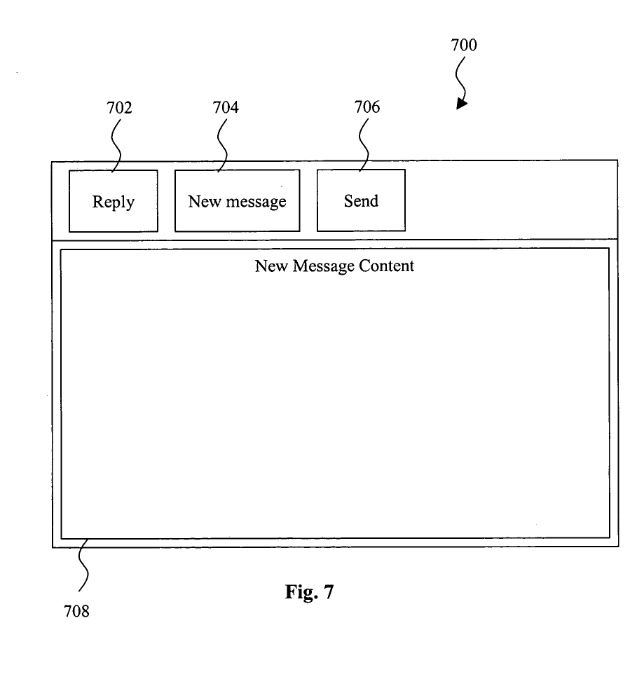

Referring now to FIG. 7, in yet another embodiment, an exemplary window 700 enables a user to access received email without having full access to a computer or other device receiving the email. In the present example, the window 700 is a pop-up window that appears while a screen saver is running. The window 700 includes a plurality of email operation buttons, such as a Reply button 702, a New Mail button 704, and a Send button 706. The window 700 may also include a text box 708 into which messages may be entered. In some embodiments, as a protective measure, the user may be unable to delete a received email without deactivating the screen saver. In other embodiments, the window 700 may give the user complete control of the received email.

The present disclosure has been described relative to a preferred embodiment. Improvements or modifications that become apparent to persons of ordinary skill in the art only after reading this disclosure are deemed within the spirit and scope of the application. The present disclosure may be applied and implemented on a variety of technologies. It is understood that several modifications, changes and substitutions are intended in the foregoing disclosure and in some instances some features of the disclosure will be employed without a corresponding use of other features. Accordingly, it is appropriate that the appended claims be construed broadly and in a manner consistent with the scope of the disclosure.

1. A method for providing secure access to a message on a digital device using a screen saver, the method comprising:
activating the screen saver if no activity is detected within a predefined period of time;
determining if a message has been received;
determining whether the screen saver is active;
identifying a message notification configuration if a message is received and the screen saver is active, wherein the message notification configuration identifies at least one user-defined destination at which a user is to be notified;
notifying the user of the received message at the destination;
executing an authorization routine to determine whether the user has entered a correct authorization code; and
providing the message to the user at the destination without disabling the screen saver if the user has entered the correct authorization code.

2. The method of claim 1 further comprising displaying the message to the user without executing the authorization routine if the screen saver is not active.

3. The method of claim 1 wherein providing the message to the user at the destination includes determining if the message is to be delivered as a voice message or as a text message, and converting the message to a voice message if required.

4. The message of claim 3 wherein the destination is a mobile device, and wherein providing the message to the user at the destination includes sending the message through a network.

5. The method of claim 4 wherein the network includes a public branch exchange.

6. The method of claim 1 wherein providing the message to the user without disabling the screen saver includes displaying the email in a pop-up window that is accessible while the screen saver is active.

7. The method of claim 6 wherein the pop-up window includes a plurality of message buttons that enable the user to respond to the message while the screen saver is active.

8. The method of claim 7 wherein the message can be deleted only after deactivating the screen saver.

9. The method of claim 1 wherein the entered authorization code is a biometric identifier, and wherein executing the authorization routine includes comparing the entered biometric identifier to a stored biometric identifier.

10. A method for providing secure access to messages on a digital device, the method comprising:
monitoring an email system for a message;
determining whether a message has been received or a predefined period of time has elapsed without user activity;
if a message has been received, determining whether the message meets at least one predefined criterion;
activating a screen saver if the message meets the at least one predefined criterion or if the predefined period of time has elapsed without user activity;
checking at least one configuration setting to identify a user-defined action for the received message; and
notifying the user of the received message based on the configuration setting; and
providing the received message to the user without deactivating the screen saver.

11. The method of claim 11 wherein the predefined criterion is a priority of the received message.

12. The method of claim 10 further comprising enabling the user to respond to the message while the screen saver is active.

13. The method of claim 10 wherein the user-defined action includes forwarding the message to a destination identified by the user.

14. The method of claim 10 wherein the destination is a mobile device, and wherein forwarding the message includes sending the message through an intermediate network.

15. A system for providing secure access to a messages using a screen saver, the system comprising:
a processor;
a memory accessible to the processor; and
a plurality of instructions stored in the memory for execution by the processor, the instructions including:
an instruction for activating a screen saver if no activity is detected within a predefined period of time;
an instruction for determining if a message has been received;
an instruction for determining whether the screen saver is active;
an instruction for retrieving a message notification configuration if a message is received and the screen saver is active, wherein the message notification configuration identifies at least one user-defined destination at which a user is to be notified;
an instruction for notifying the user of the received message at the destination;
an instruction for executing an authorization routine to determine whether the user has entered a correct authorization code; and
an instruction for providing the message to the user at the destination without disabling the screen saver if the user has entered the correct authorization code.

16. The system of claim 15 further comprising an instruction for displaying the message to the user without executing the authorization routine if the screen saver is not active.

17. The system of claim 15 wherein providing the message to the user without disabling the screen saver includes displaying the email in a pop-up window that is accessible while the screen saver is active.

18. The system of claim 17 wherein the pop-up window includes a plurality of message buttons that enable the user to respond to the message while the screen saver is active.

19. The system of claim 18 wherein the message can be deleted only after deactivating the screen saver.

20. The method of claim 15 wherein the system further comprises email software.
